(19) United States
(12) Patent Application Publication
(10) Pub. No.: US 2011/0084651 A1
(43) Pub. Date: Apr. 14, 2011

(54) Charging station

(75) Inventors: Henry D. Caskey, Cicero, IN (US); David A. Benedetti, Carmel, IN (US)

(73) Assignee: Audiovox Corporation, Hauppauge, NY (US)

(21) Appl. No.: 12/924,875

(22) Filed: Oct. 7, 2010

Related U.S. Application Data
(60) Provisional application No. 61/278,582, filed on Oct. 8, 2009.

(51) Int. Cl. H02J 7/00

(52) U.S. Cl. 320/107

(57) ABSTRACT

A charging station for charging an electrical device, such as a cellular phone, has a housing, an electrical power plug mounted on a rear portion of the housing which is receivable by a wall mounted electrical power receptacle, an electrical power outlet mounted on a lateral side of the housing, and a universal serial bus (USB) connector mounted on a front face of the housing. A cradle is formed in an upper portion of the housing for supporting an electrical device being charged by the charging station.

### CROSS-REFERENCE TO RELATED APPLICATION

This application is related to U.S. Provisional Application Ser. No. 61/278,582, which was filed on Oct. 8, 2009, and is entitled “Charging Station”, the disclosure of which is hereby incorporated by reference and on which priority is hereby claimed.

### BACKGROUND OF THE INVENTION

1. Field of the Invention

The present invention relates to devices for charging electrical equipment, such as cellular telephones, calculators, hand held gaming devices, digital cameras and the like.

2. Description of the Prior Art

Devices for charging portable electrical equipment, such as cellular telephones, hand held gaming devices, digital cameras, PDAs, calculators and the like usually plug into a wall outlet (120 volts AC) and include an AC to DC converter, which is coupled to a rather lengthy wire at one end whose opposite end is coupled to a connector which plugs into the electrical equipment to be charged. Many consumers charge these small appliances or electrical devices in their kitchen (which is becoming the most often used room in the home), plugging the charging unit into a wall outlet and placing the electrical device on a kitchen countertop as the device is being charged. The problem with this conventional method of charging a device is that the device being charged occupies the limited counter space in the kitchen and could be subject to damage due to spilled water or the like. Furthermore, the charging electrical cord, usually about three feet in length, loosely lies on the countertop in an unsightly manner and may become entangled with objects residing on the countertop.

### OBJECTS AND SUMMARY OF THE INVENTION

It is an object of the present invention to provide a charging station for electrically charging a small appliance or electrical device which requires no countertop space for charging the appliance or device.

It is another object of the present invention to provide a charging station for a small appliance or electrical device which maintains the appliance or device in a safe location away from damage due to water spillage and the like.

It is yet a further object of the present invention to provide a charging station for charging a small appliance or electrical device, which maintains the location at which the small appliance or electrical device is charged in a neat and organized condition.

It is still another object of the present invention to provide a charging station for charging a portable electrical device which includes structure for wrapping thereabout the charging cord of the device's charger in a neat and orderly manner.

A charging station formed in accordance with the present invention is adapted to be mounted into a household AC wall outlet and held thereby. The charging station includes a housing having a cradle formed in a top portion thereof which is adapted to hold one or more electrical devices (e.g., cellular telephone, PDA, calculator, digital camera or the like) in a safe location and away from a countertop or other horizontal surface, where the electrical device may be damaged from water spillage and the like or which would otherwise have occupied space on the countertop or horizontal surface. The charging station of the present invention further preferably includes surge protection for the electrical device which is connected to it during charging of the device.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1A is a front view of a general form of a charging station constructed in accordance with the present invention and holding two electrical devices for charging.

FIG. 1B is a side view of the general form of the charging station constructed in accordance with the present invention and shown in FIG. 1A, and further illustrating how electrical devices may be held by the charging station.

FIG. 1 is a front perspective view of a first embodiment of a charging station formed in accordance with the present invention.

FIG. 2 is a rear perspective view of the first embodiment of the charging station formed in accordance with the present invention.

FIG. 3 is a front elevational view of the first embodiment of the charging station formed in accordance with the present invention.

FIG. 4 is a rear elevational view of the first embodiment of the charging station formed in accordance with the present invention.

FIG. 5 is a left elevational view of the first embodiment of the charging station formed in accordance with the present invention, a right elevational view thereof being the same as the left elevational view shown in FIG. 5.

FIG. 6 is a top plan view of the first embodiment of the charging station formed in accordance with the present invention.

FIG. 7 is a bottom plan view of the first embodiment of the charging station formed in accordance with the present invention.

FIG. 8 is a front perspective view of a second embodiment of a charging station/power outlet formed in accordance with the present invention.

FIG. 9 is a rear perspective view of the second embodiment of the charging station/power outlet formed in accordance with the present invention.

FIG. 10 is a front elevational view of the second embodiment of the charging station/power outlet formed in accordance with the present invention.

FIG. 11 is a rear elevational view of the second embodiment of the charging station/power outlet formed in accordance with the present invention.

FIG. 12 is a left elevational view of the second embodiment of the charging station/power outlet formed in accordance with the present invention.

FIG. 13 is a right elevational view of the second embodiment of the charging station/power outlet formed in accordance with the present invention.

FIG. 14 is a top plan view of the second embodiment of the charging station/power outlet formed in accordance with the present invention.

FIG. 15 is a bottom plan view of the second embodiment of the charging station/power outlet formed in accordance with the present invention.

FIG. 16 is a front perspective view of a third embodiment of a charging station formed in accordance with the present invention.

FIG. 17 is a rear perspective view of the third embodiment of the charging station formed in accordance with the present invention.

FIG. 18 is a front elevational view of the third embodiment of the charging station formed in accordance with the present invention.

FIG. 19 is a rear elevational view of the third embodiment of the charging station formed in accordance with the present invention.

FIG. 20 is a top plan view of the third embodiment of the charging station formed in accordance with the present invention.

FIG. 21 is a bottom plan view of the third embodiment of the charging station formed in accordance with the present invention.

FIG. 22 is a left elevational view of the third embodiment of the charging station formed in accordance with the present invention.

FIG. 23 is a right elevational view of the third embodiment of the charging station formed in accordance with the present invention.

FIG. 24 is a front perspective view of a fourth embodiment of a charging station formed in accordance with the present invention.

FIG. 25 is a rear perspective view of the fourth embodiment of the charging station formed in accordance with the present invention.

FIG. 26 is a front elevational view of the fourth embodiment of the charging station formed in accordance with the present invention.

FIG. 27 is a rear elevational view of the fourth embodiment of the charging station formed in accordance with the present invention.

FIG. 28 is a top plan view of the fourth embodiment of the charging station formed in accordance with the present invention.

FIG. 29 is a bottom plan view of the fourth embodiment of the charging station formed in accordance with the present invention.

FIG. 30 is a left elevational view of the fourth embodiment of the charging station formed in accordance with the present invention.

FIG. 31 is a right elevational view of the fourth embodiment of the charging station formed in accordance with the present invention.

FIG. 32 is a front perspective view of a fifth embodiment of a charging station formed in accordance with the present invention.

FIG. 33 is a rear perspective view of the fifth embodiment of the charging station formed in accordance with the present invention.

FIG. 34 is a front elevational view of the fifth embodiment of the charging station formed in accordance with the present invention.

FIG. 35 is a rear elevational view of the fifth embodiment of the charging station formed in accordance with the present invention.

FIG. 36 is a left elevational view of the fifth embodiment of the charging station formed in accordance with the present invention, a right elevational view thereof being the same as the left elevational view shown in FIG. 36;

FIG. 37 is a top plan view of the fifth embodiment of the charging station formed in accordance with the present invention.

FIG. 38 is a bottom plan view of the fifth embodiment of the charging station formed in accordance with the present invention.

FIG. 39 is a block diagram of an electrical circuit of the charging station formed in accordance with the present invention.

FIG. 40 is a front elevational view of a sixth embodiment of the charging station formed in accordance with the present invention and illustrating extendible arms for supporting an electrical device thereon.

FIG. 41 is a side view of the charging station of the present invention shown in FIG. 40.

FIG. 42 is a front perspective view of a seventh embodiment of a charging station formed in accordance with the present invention and illustrating extendible arms for supporting an electrical device thereon.

FIG. 43 is a front elevational view of an eighth embodiment of a charging station formed in accordance with the present invention and illustrating extendible arms for supporting an electrical device thereon.

FIG. 44 is a front perspective view of a ninth embodiment of a charging station formed in accordance with the present invention and illustrating extendible arms for supporting an electrical device thereon.

FIG. 45 is a rear perspective view of the charging station of the present invention shown in FIG. 44.

FIG. 46 is a front perspective view of a tenth embodiment of a charging station formed in accordance with the present invention and illustrating extendible arms for supporting an electrical device thereon.

FIG. 47 is a rear perspective view of the charging station of the present invention shown in FIG. 46.

### DETAILED DESCRIPTION OF THE PREFERRED EMBODIMENTS

In accordance with one form of the present invention, a charging station 2 for charging a small appliance or electrical device 3 includes a housing 4 which is preferably formed from two mateable front and rear portions 6, 8. The rear portion 8 of the housing includes an electrical plug 10 in the form of two contacts 12 and a ground pin 14 which may be plugged directly into a household wall outlet providing 120 volts AC. The rear portion 8 of the housing 4 may further include a non-conductive pin 16 extending outwardly therefrom and situated in alignment and spaced apart from the electrical plug, which non-conductive pin 16 may be received by the ground female contact of a second wall outlet situated in alignment with the first wall outlet in which the electrical plug 10 is received. This non-conductive pin 16, which is received by the second wall outlet, is used to provide stability to the charging station 2 and to help align the charging station with the household wall outlet as the charging station 2 is being mounted on the household wall outlet (most wall outlets have at least two pairs of electrical plug-in female contacts, each with a ground contact).

At least one, but preferably two, USB ports or connectors 18 are situated on the front face 19 of the front portion 6 of the housing 4 of the charging station, or at another location on the housing. Furthermore, at least one, but preferably two or more, 120 volt outlets 20 are mounted on either one or both lateral side walls 22 of the housing 4, or elsewhere on the housing. Many cellular telephones and other electrical devices may be charged directly from a USB port or connector which provides a 5 volt DC power signal on a particular pin of the USB connector, as is standard in the industry. Accordingly, the charging station 2 of the present invention provides preferably two such USB ports or connectors 18 so that one or more electrical devices 3 may be connected to the one or more USB ports or connectors 18 preferably situated on the front face 19 of the charging station 2 using a compatible interconnecting wire usually provided with the cellular phone, digital camera or other electrical device for such purposes.

For those electrical devices 3 which have an AC/DC converter module and a length of wire connected thereto, which is connectable to the electrical device, the module may be plugged into one of the power outlets 20 situated on one or both of the lateral side walls 22 of the charging station housing.

As can be seen from the drawings, the upper portion 24 of the housing 4 defined by the mateable front and rear portions 6, 8 thereof includes a pocket or slot (also referred to herein as a “cradle”) 26 that extends preferably across the upper portion 24 of the housing 4 between the lateral sides 22 thereof. The cradle or slot 26 has a depth and a width which are selected to receive one or more of the electrical devices 3 (e.g., cellular telephones, hand held gaming devices, PDAs, shavers or the like) and hold such electrical devices in a safe and convenient location on the charging station 2, as shown in the drawings. In this way, the electrical devices 3 do not have to occupy space on the countertop or other horizontal surface when being charged and are not subject to damage from liquid spillage and the like.

Accordingly, the charging station 2 of the present invention is adapted to hold the portable electrical device 3 during charging, as well as providing a location for maintaining the device 3 when the device is not being used so that the device can be easily found. Furthermore, the charging station 2 of the present invention, with its top cradle 26, keeps the device 3 clean and out of harm's way while the device is being charged.

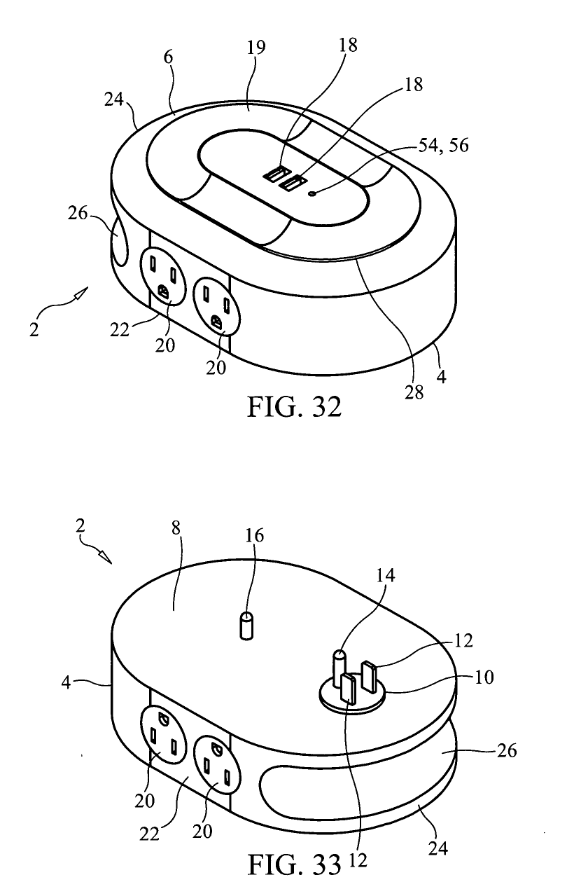

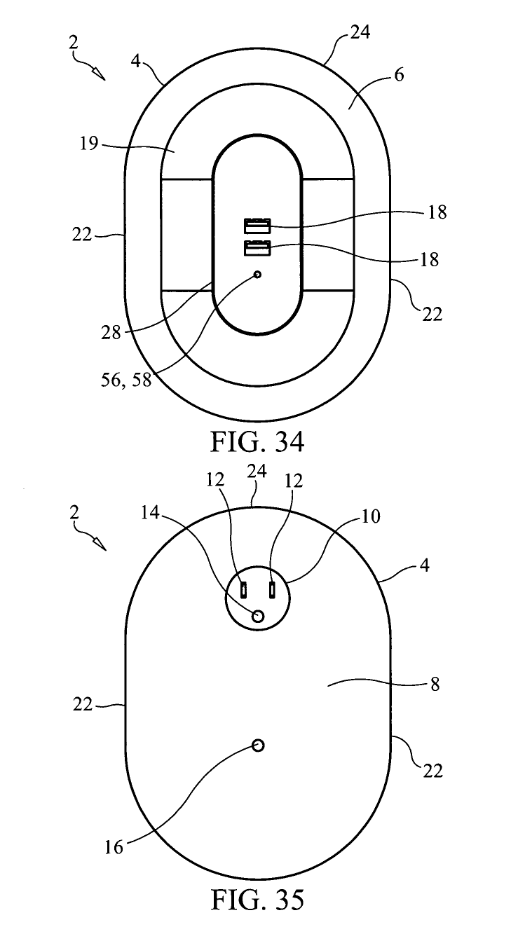

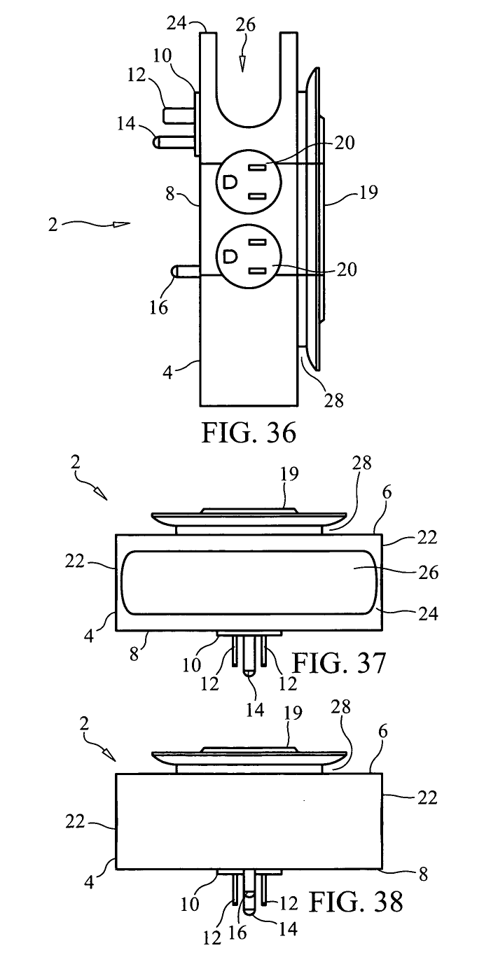

As shown in FIGS. 32-38 of the drawings, the charging station housing 4 may include a slot 28 formed circumferentially about the front face 19 thereof to receive the charging cord of the device 3 and permit the charging cord to be wrapped about the charging station 2 in a neat and orderly fashion, rather than leaving the charging cord loose and resting on the countertop when the device 3 is being charged.

As shown in FIGS. 40-47, the charging station of the present invention may further include fold out or extendible arms 30 situated on the opposite lateral sides 22 of the housing 4, which the user may unfold to a substantially horizontal position so that they extend outwardly from each lateral side 22 in proximity to the cradle or pocket 26 formed in the upper portion 24 of the housing. Each arm 30 may be several inches in length and, in their extended position, the arms 30 provide a supporting surface preferably in alignment with the bottom surface of the cradle 26 for supporting larger electrical devices 3 in the cradle of the charging station 2 of the present invention.

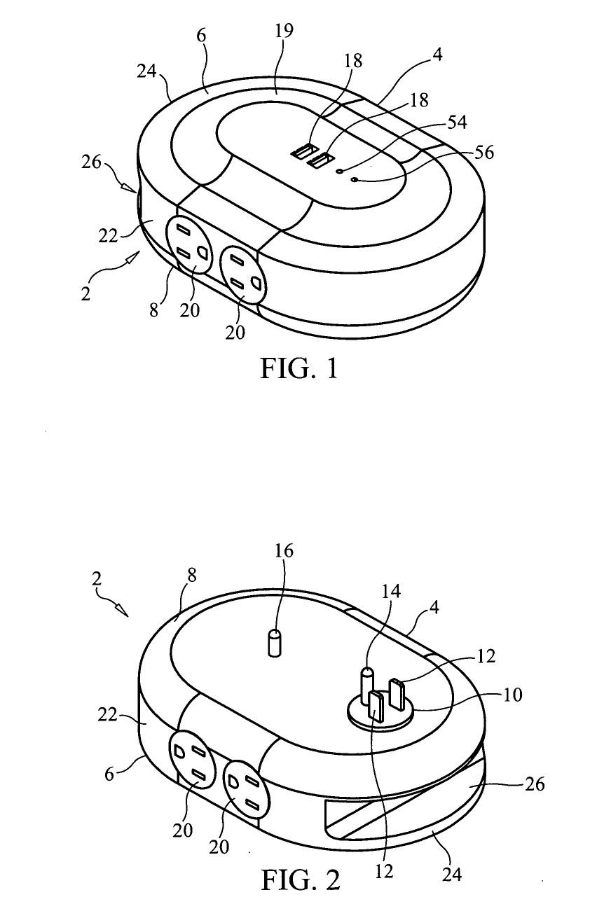

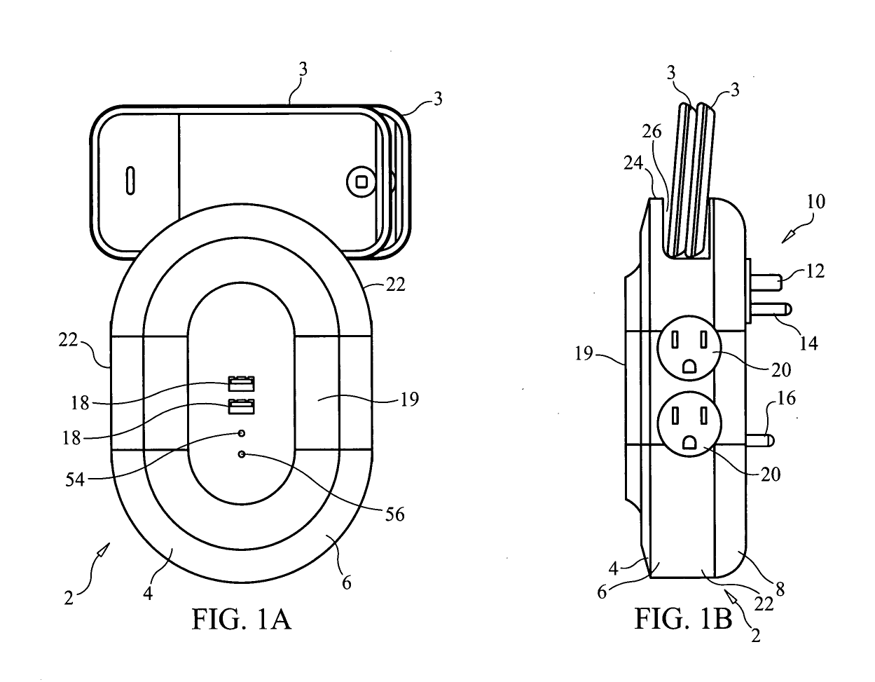

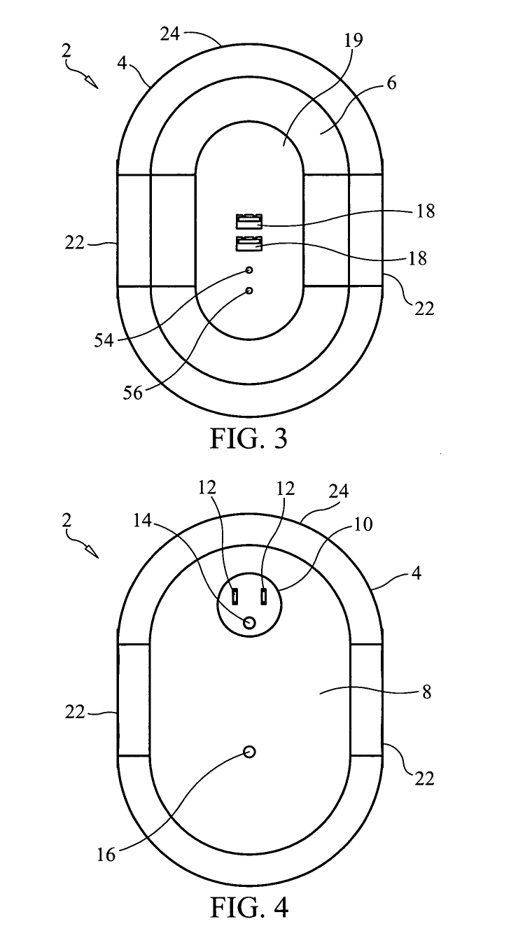

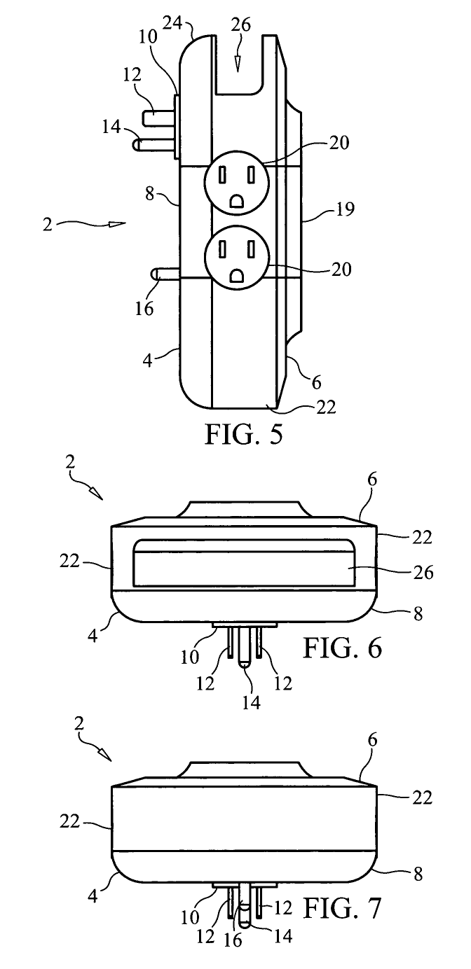

More specifically, and with reference to FIGS. 40 and 41, the first embodiment of the charging station 2 of the present invention shown in FIGS. 1-7 has been modified to include extendible arms 30 for supporting an electrical device 3 to be charged by the charging station 2, in the event that the electrical device 3 has a width which exceeds the width of the cradle 26 and may require additional support. Each arm 30 extends from a respective lateral side wall 22 of the charging station 2 through a slot 32 formed through the thickness of the housing 4. Each arm 30 may be extended and retracted by a user of the charging station 2 through its corresponding slot 32. The support arms 30 are situated in alignment with or in close proximity to the most recessed portion of the cradle 26 so that the support arms 30 may be in close proximity to the lower portion or underside of an electrical device 3 resting in the cradle 26 of the charging station 2.

Each support arm 30 includes a free end 34 which may be curved out of the plane in which the major segment 36 of each arm resides to form a hooked end disposed at preferably a 90 degree angle with respect to the major segment 36 of the support arm 30. The hooked end 34 helps maintain the electrical device 3 resting in the cradle 26 of the charging station in a position in which the electrical device is at least partially resting on the support arm 30 or where the support arm 30 is in proximity to the underside of the electrical device, and the hooked ends 34 help prevent oversized electrical devices 3 from moving sideways or becoming unbalanced and possibly falling off the charging station 2 on which it rests.

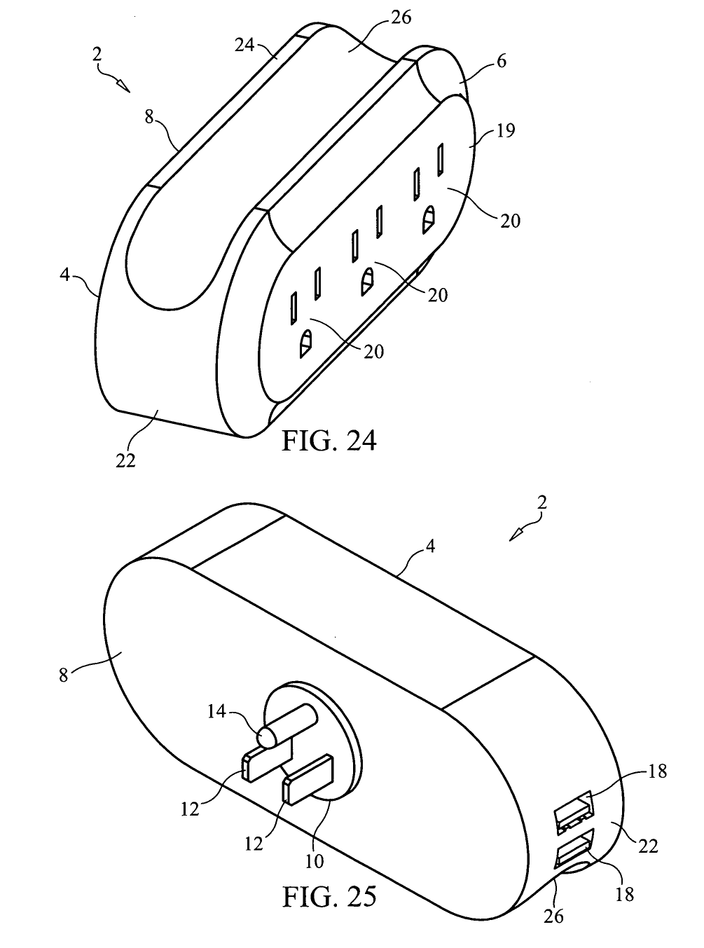

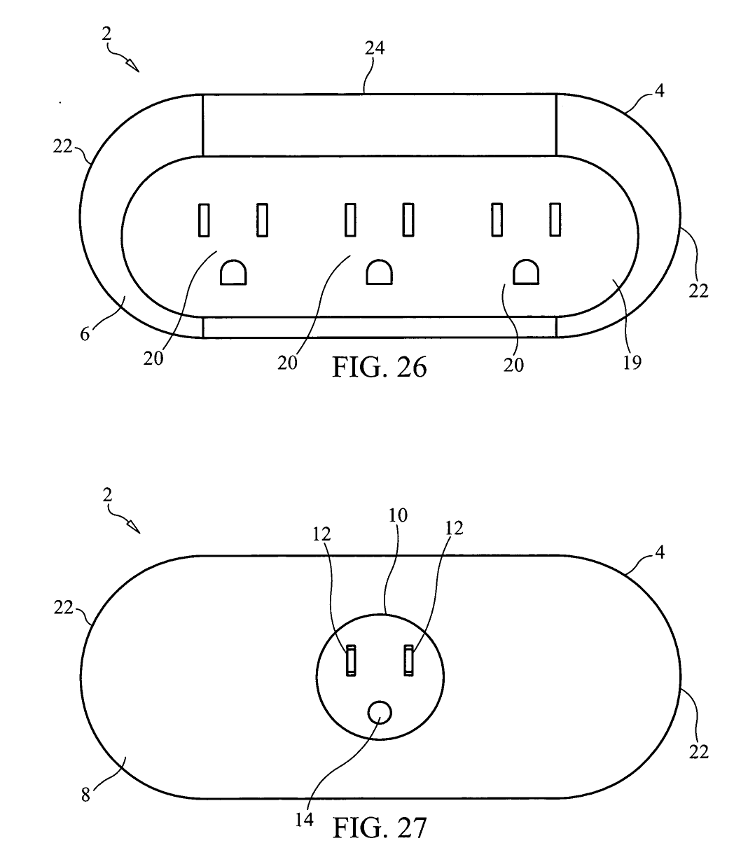

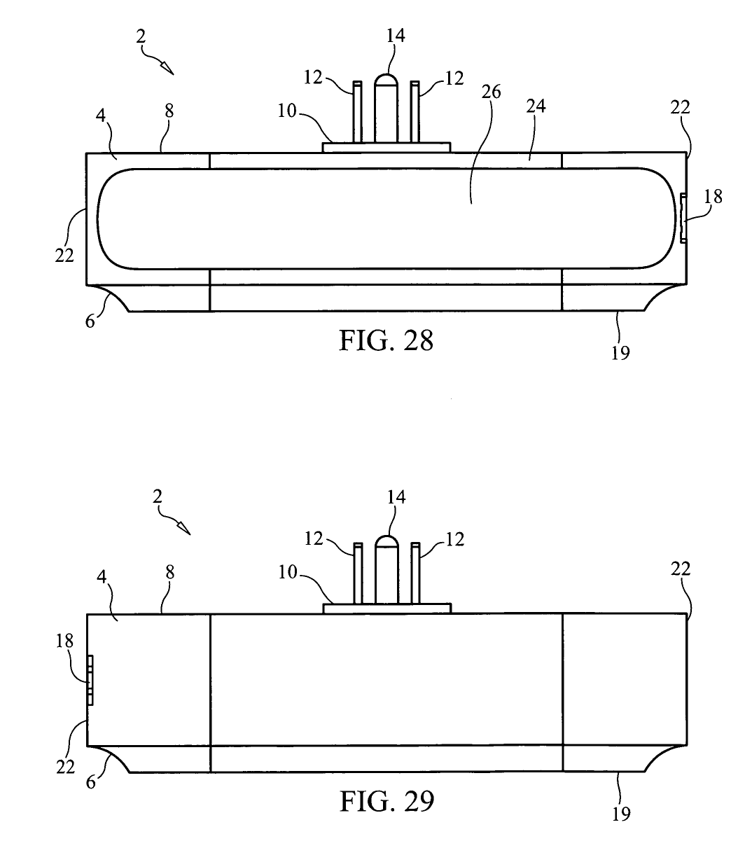

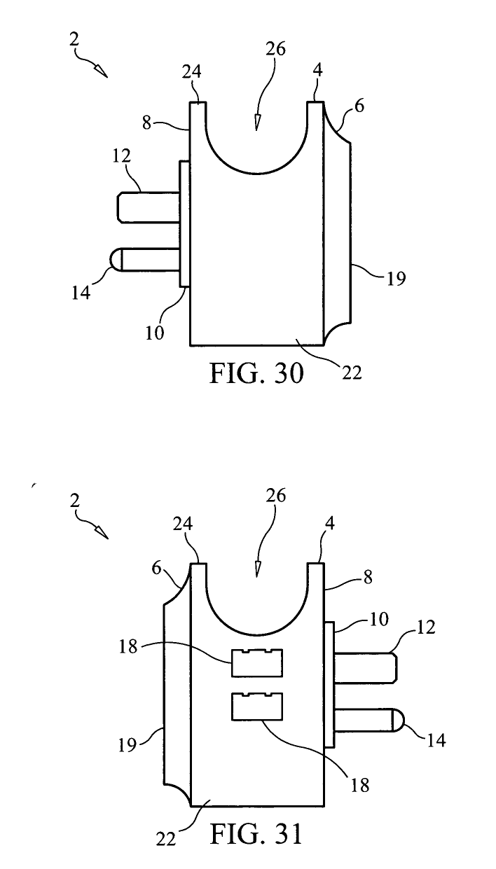

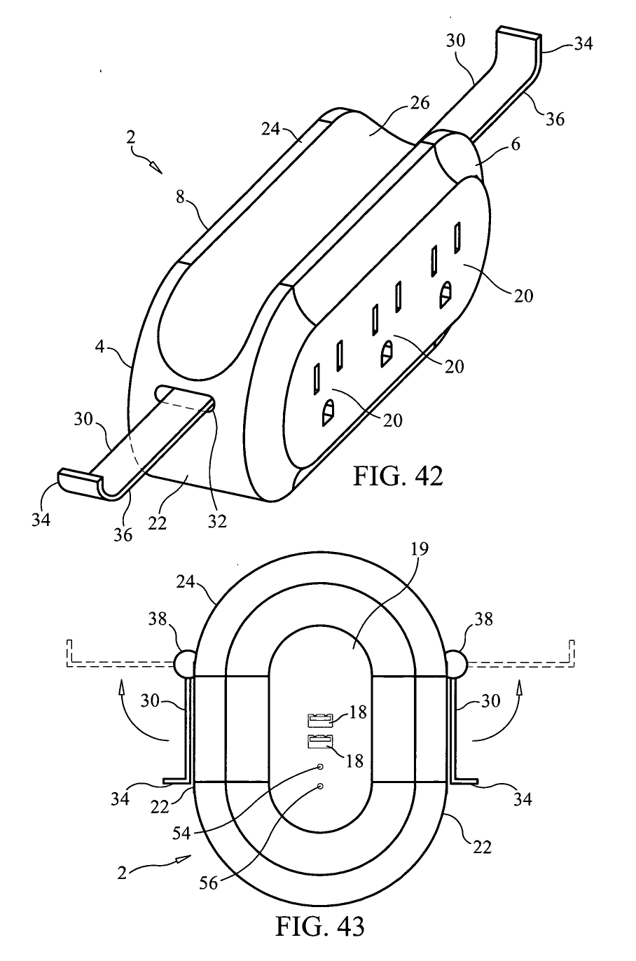

FIG. 42 is a view of the fourth embodiment of the charging station 2 described previously and shown in FIGS. 24-31, modified to include such extendible arms 30 shown in FIGS. 40 and 41.

FIG. 43 illustrates a modification of the first embodiment of the charging station 2 shown in FIGS. 1-7, where the extendible arms 30 for supporting an electrical device 3 on the charging station are pivotally mounted on opposite lateral side walls 22 of the housing 4 of the charging station. Each extendible arm 30 is mounted to a corresponding pivot mechanism 38 affixed to a lateral side wall 22 of the housing 4, and can be pivoted upwardly from a first position in which it is residing along a portion of the length of the lateral side wall 22 to a second position where it extends perpendicularly outwardly from the corresponding lateral side wall 22 on which it is pivotally mounted. Again, as with the embodiment shown in FIGS. 40-42, each support arm 30 is preferably situated in alignment with, or in proximity to, the lowest recessed portion of the cradle 26 so that the support provided by the cradle 26 is effectively extended in width by the support arms 30 when they are placed in the second position.

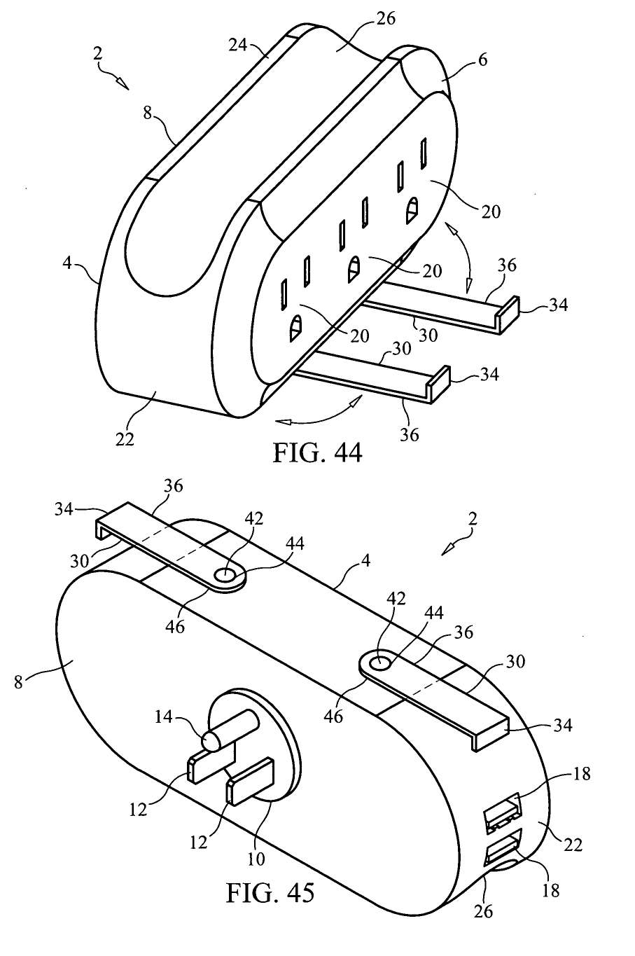

FIGS. 44 and 45 illustrate another version of the support arms 30 which may be used to support an electrical device 3 to be charged by the charging station 2 when the thickness or width of the electrical device may be greater than that of the cradle 26 formed in the upper portion 24 of the housing 4 of the charging station. In the example shown in FIGS. 44 and 45, the fourth embodiment of the charging station 2 shown in FIGS. 24-31 has been modified to add such extendible arms 30. The arms 30 are pivotally mounted on the underside, or lower portion 40, of the housing 4 of the charging station 2 by pivot pins 42 received through holes 44 formed through the thickness of each support arm 30 at one end 46 thereof (the end opposite the hooked end 34). The pins 42 are attached to the housing 4 of the charging station 2 so that the support arms 30 may be pivoted thereon from a first position, where they extend in opposite directions from each other and lengthwise on the charging station 2, to a second position, in which they are disposed in parallel with one another and extending outwardly in front of the front face 19 of the charging station 2.

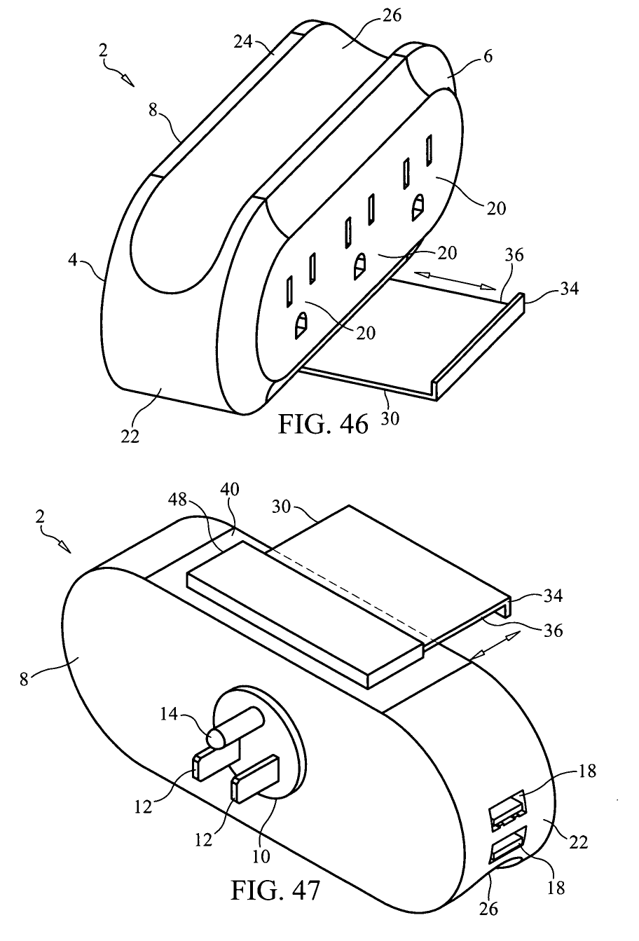

FIGS. 46 and 47 illustrate another form of a support arm for supporting an electrical device 3 thereon, in the event that the electrical device may not fit within the cradle 26. In the example shown in FIGS. 46 and 47, the fourth embodiment of the charging station shown in FIGS. 24-31 has been modified to include a telescopic extendible and retractable support arm 30 in the form of a tray having a hooked free end 34 extending perpendicularly from the major segment 36 of the support arm 30. In this embodiment, the support arm 30 may be received telescopically within a pocket housing 48 mounted to the underside or lower portion 40 of the housing 4 of the charging station 2, and may be extended and retracted by the user from the pocket housing 48.

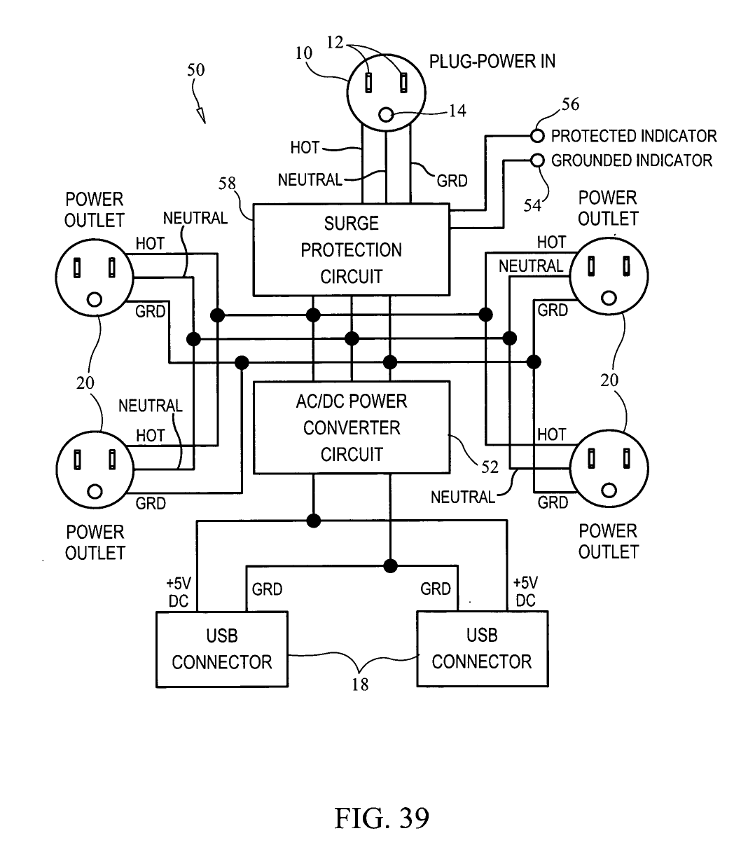

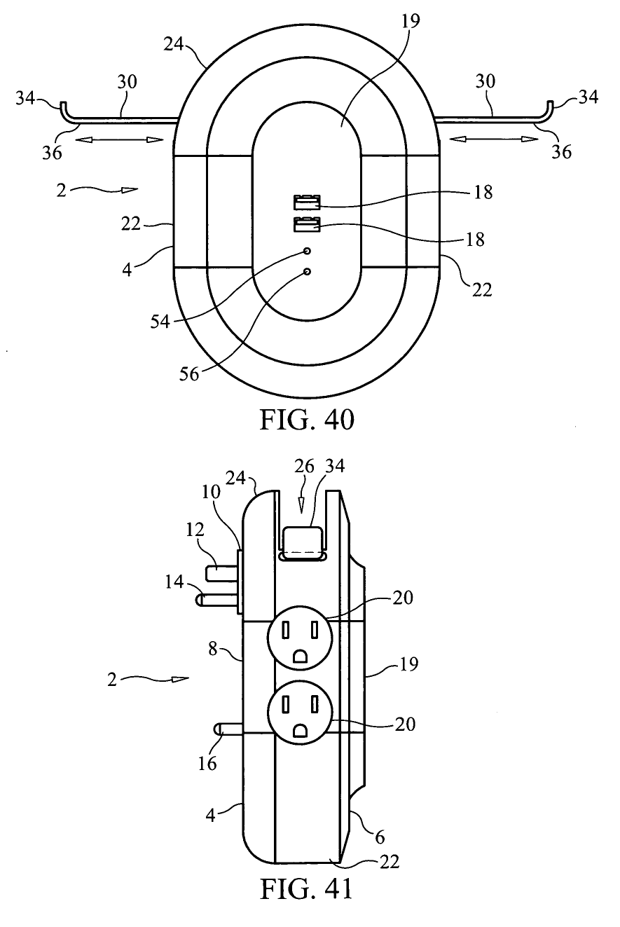

A schematic diagram of the electrical circuit 50 of the charging station 2 of the present invention, in one form thereof, is shown in FIG. 39. The circuit 50 includes an electrical plug 10 extending from the rear portion 8 of the housing 4 of the charging station 2, as described previously, which is connectable to the household wall outlet to receive 120 volts AC on the polarized electrical contacts thereof. The contacts 12 of the electrical plug 10 are connected via wires to not only the side-mounted electrical outlets 20 of the charging station, but also to an AC/DC power converter circuit 52, which provides on its output preferably a 5 volt DC signal. The 5 volt DC signal is connected to a particular pin on each of the front-mounted pair of USB connectors or ports 18 via an electrical wire. A ground connection to a particular pin on each USB connector or port 18 is also connected via a wire to a ground connection on the power converter circuit 52. The power converter circuit 52 is also preferably connected to the ground pin of the wall outlet through the 120 volt plug 10 and ground pin 14 situated on the rear portion 8 of the housing 4 through an interconnecting wire or wires.

Preferably, the front face 19 of the front portion 6 of the housing 4 of the charging station 2 includes two LEDs (light emitting diodes) 54, 56, which may light with the same or different colors. More specifically a “grounded indicator” LED 54 indicates that the charging station 2 is providing a proper ground to the electrical device 3 being charged and connected thereto. A “protected indicator” LED 56 indicates that the charging station 2 is providing surge protection to the electrical device 3 connected thereto, as is further explained below.

Preferably, the circuit 50 of the charging station 2 further includes a surge protection circuit 58, which may include a Sidactor or other semiconductor device well known to those skilled in the art, to provide surge protection for the electrical device 3 connected to the charging station 2. The surge protection circuit 58 is preferably electrically interposed between the power converter circuit 52 and the 120 volt AC plug 10 to provide surge protection for not only the electrical device 3 but also the power converter circuit 52 used in the charging station 2. The surge protection circuit 58 generates preferably two output signals which are provided to the two LEDs 54, 56 on the front face 19 of the charging station 2, to indicate to the user that the electrical device 3 and/or the charging station 2 are properly grounded and that the electrical device connected to the charging station is protected from electrical surges.

FIGS. 1-7 illustrate one form of a charging station 2 constructed in accordance with the present invention.

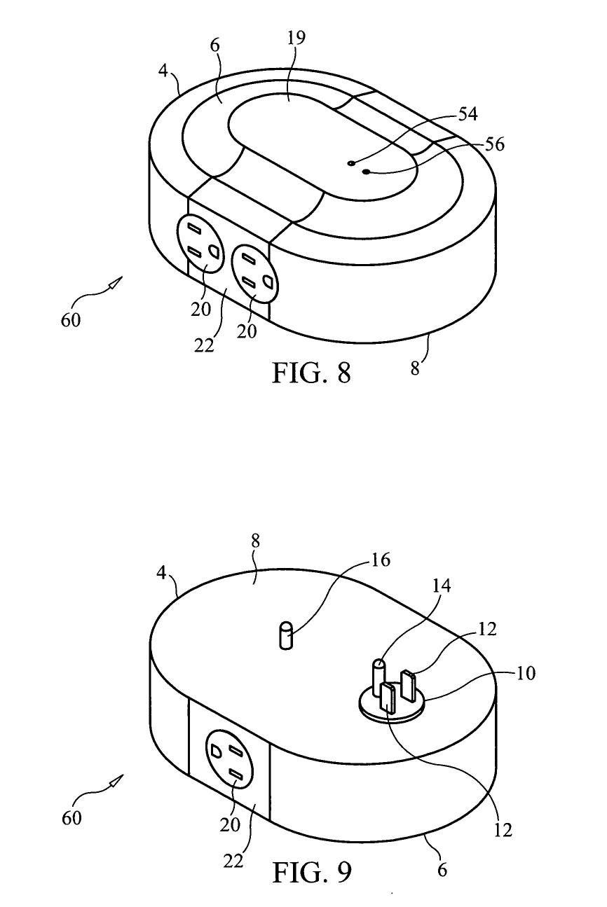

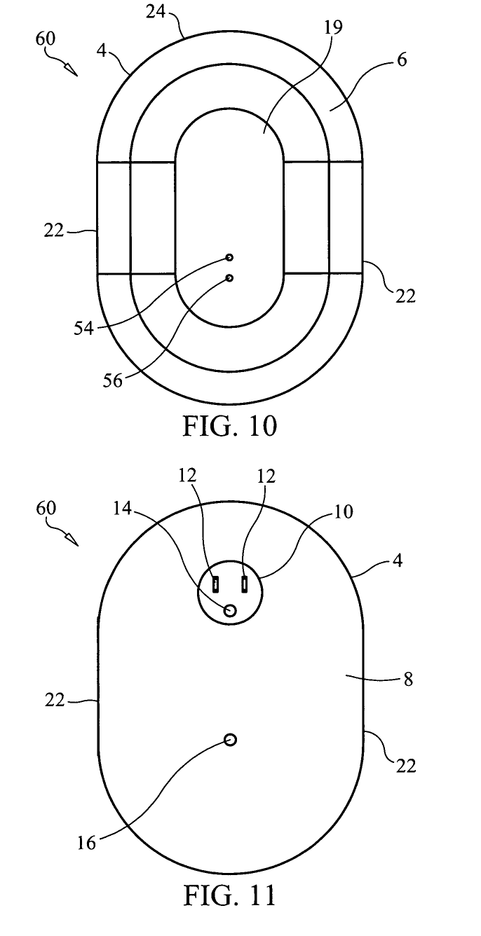

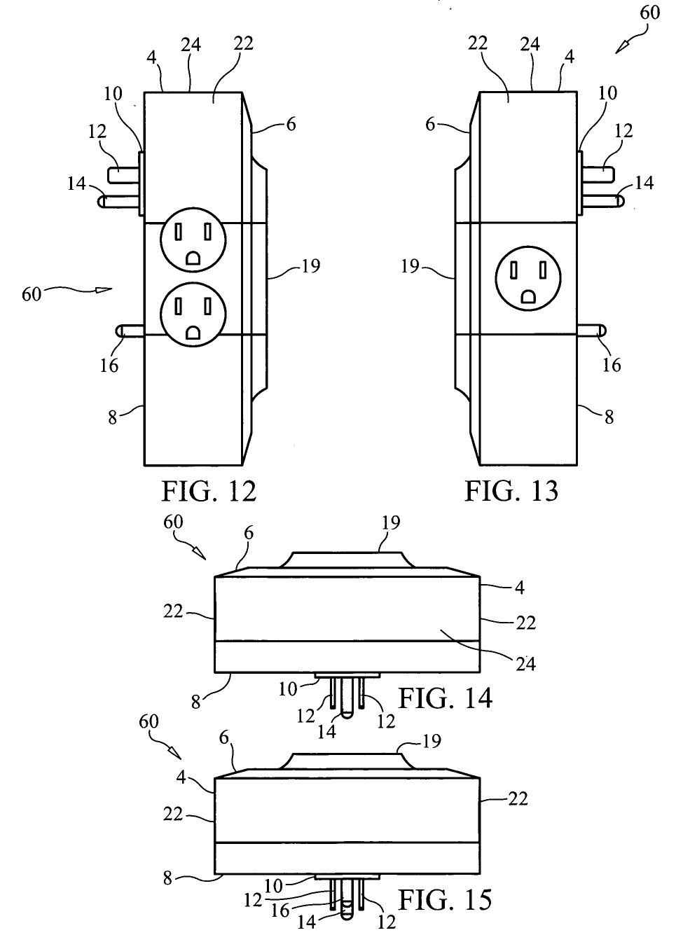

FIGS. 8-15 illustrate a power outlet 60 formed in accordance with the present invention without having a cradle 26 formed therein. This particular embodiment is useful for providing surge protection for larger (and small) appliances, such as refrigerators, where, of course, there is no need to place the appliance on top of the power outlet 60 in a cradle.

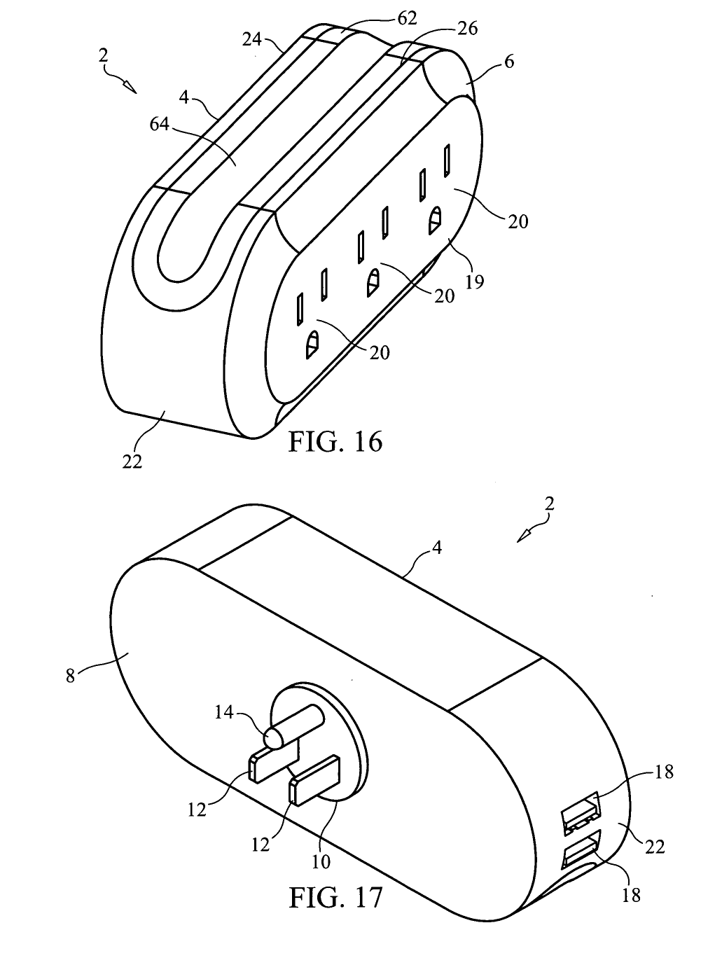

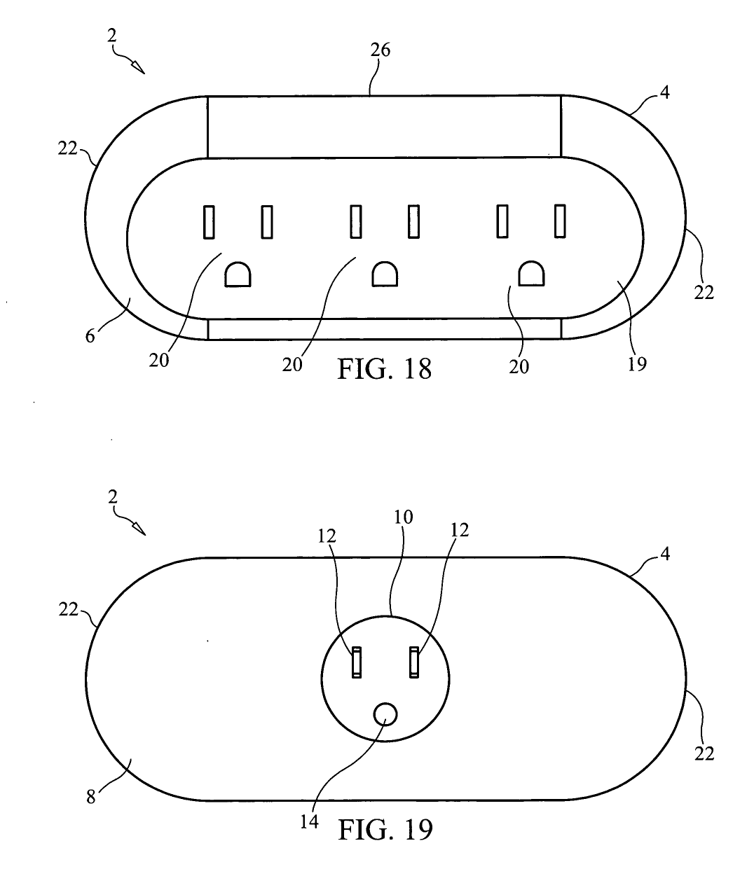

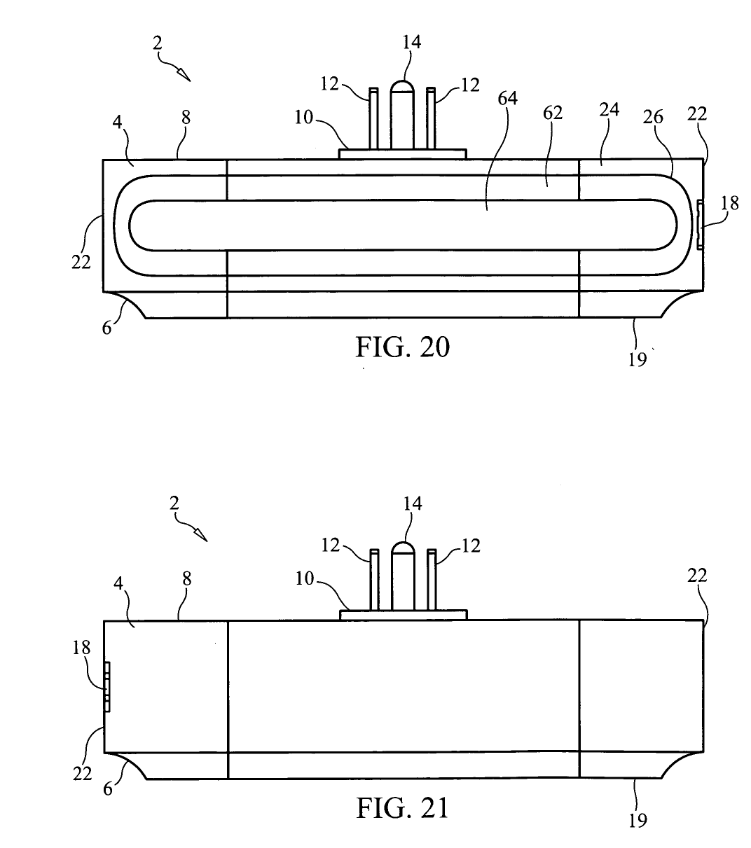

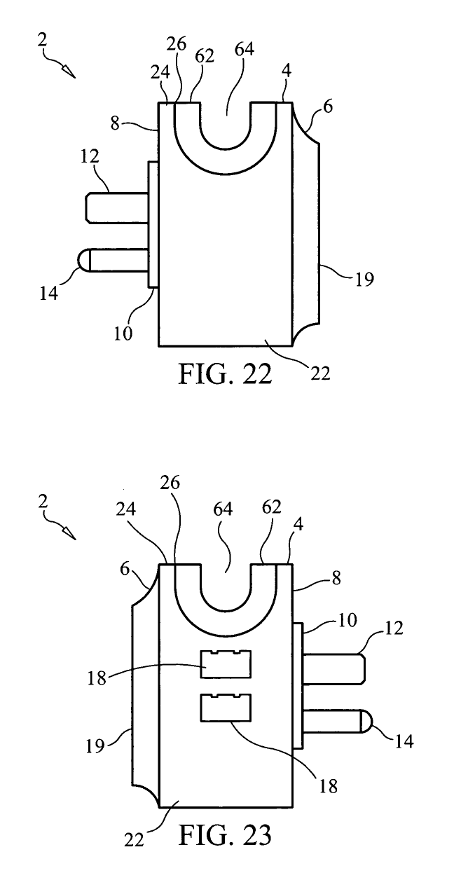

FIGS. 16-23 and FIGS. 24-31 illustrate another form of a charging station 2 constructed in accordance with the present invention. A removable U-shaped sleeve or shell 62 may be received by the cradle 26 formed in the upper portion 24 of the charging station 2, as illustrated by FIGS. 16-23. The sleeve 62 defines at its upper surface a recess 64. The sleeve 62 is provided to accommodate thinner electronic devices 3 within the recess 64 defined by the sleeve 62. For larger (wider or thicker) electronic devices 3, such as digital cameras, the sleeve 62 may be removed from the cradle 26 so that the cradle 26 can accommodate the wider or thicker electronic device 3, as illustrated by FIGS. 24-31.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A charging station for charging an electrical device, which comprises:
a housing, the housing having a front portion, a rear portion joined to the front portion, and upper portion joined to the front and rear portions, a lower portion situated opposite the upper portion, and opposite lateral side walls joined to the front and rear portions;
an electrical power plug mounted on the rear portion of the housing and having electrical contacts extending outwardly from the rear portion, the electrical contacts being receivable by electrical contacts of a wall mounted electrical power receptacle; and
at least one of 1) at least one electrical power outlet mounted on the housing and electrically connected to the electrical power plug, and 2) at least one universal serial bus (USB) connector mounted on the housing;
wherein the upper portion of the housing defines a cradle for supporting an electrical device at least partially therein.

2. A charging station as defined by claim 1, which further comprises:
an alignment pin, the alignment pin being mounted on the rear portion of the housing and extending outwardly from the rear portion, the alignment pin being spaced apart a predetermined distance from the electrical power plug mounted on the rear portion of the housing, the alignment pin being receivable by a wall mounted electrical power receptacle.

3. A charging station as defined by claim 2, wherein the alignment pin is made from a non-conductive material.

4. A charging station as defined by claim 1, wherein the housing includes a slot formed circumferentially in the front portion thereof for receiving an electrical wire of the electrical device to be charged.

5. A charging station as defined by claim 1, wherein the charging station includes the at least one electrical power outlet;
and wherein the charging station further comprises an electrical circuit, the electrical circuit having a surge protection circuit electrically coupled to the at least one electrical power outlet.

6. A charging station as defined by claim 5, wherein the electrical circuit further includes an indicator mounted on the housing, the indicator providing an indication that the surge protection circuit is providing surge protection to an electrical device electrically connected to the at least one electrical power outlet.

7. A charging station as defined by claim 5, wherein the electrical circuit further includes an indicator mounted on the housing, the indicator providing an indication that the electrical circuit is providing ground protection to an electrical device electrically connected to the at least one electrical power outlet.

8. A charging station as defined by claim 1, wherein the charging station includes the at least one USB connector;
and wherein the charging station further comprises an electrical circuit, the electrical circuit having a power converter circuit, the power converter circuit being electrically coupled to the at least one USB connector.

9. A charging circuit as defined by claim 1, which further comprises:
a removable sleeve, the removable sleeve being mounted in the cradle and being removable therefrom to allow the charging station to accommodate within the cradle electrical devices of different sizes, the sleeve having a recess formed therein for supporting the electrical device at least partially received therein.

10. A charging station as defined by claim 1, which further comprises:
at least one extendable support arm, the at least one extendable support arm being mounted on the housing and being extendable outwardly therefrom to at least partially support the electrical device thereon.

11. A charging station as defined by claim 10, wherein the at least one extendable support arm includes a curved free end to help maintain the electrical device in a position in which the electrical device is at least partially resting on the support arm.

12. A charging station as defined by claim 10, wherein the at least one extendable support arm is mounted to the lower portion of the housing and extendable therefrom to a position in which it is extended outwardly of the front portion of the housing.

13. A charging station as defined by the claim 10, wherein the at least one extendable support arm is reciprocatingly extendable and retractable from a lateral side wall of the housing in proximity to the cradle formed in the upper portion of the housing.
